(19) United States
(12) Patent Application Publication
(10) Pub. No.: US 2015/0136946 A1
(43) Pub. Date: May 21, 2015

(54) OPTICAL TOUCH APPARATUS AND TOUCH METHOD THEREOF

(71) Applicants: Pen-Ning Kuo, Hsin-Chu (TW); Chung-Lung Yang, Hsin-Chu (TW); Kuo-Yuan Liang, Hsin-Chu (TW); Kuan-Ta Huang, Hsin-Chu (TW)

(72) Inventors: Pen-Ning Kuo, Hsin-Chu (TW); Chung-Lung Yang, Hsin-Chu (TW); Kuo-Yuan Liang, Hsin-Chu (TW); Kuan-Ta Huang, Hsin-Chu (TW)

(73) Assignee: Coretronic Corporation, Hsin-Chu (TW)

(21) Appl. No.: 14/459,301

(22) Filed: Aug. 13, 2014

(30) Foreign Application Priority Data
Nov. 15, 2013 (CN) 201310578272.5

(51) Int. Cl. G06F 3/042

(52) U.S. Cl. CPC G06F 3/0421
USPC 250/206.1

(57) ABSTRACT

An optical touch apparatus and a touch method thereof are provided. A plurality of light sensing units are disposed between a first scanning light source and a second scanning light source, wherein the light sensing units, the first scanning light source and the second scanning light source are disposed at a same side of a touch surface. A touch position of an input tool is determined according to an intensity of a scattered light generated by an input tool and sensed by the light sensing units and generated when a first scanning beam and a second scanning beam scan the input tool.

### CROSS-REFERENCE TO RELATED APPLICATION

This application claims the priority benefit of China application serial no. 201310578272.5, filed on Nov. 15, 2013. The entirety of the above-mentioned patent application is hereby incorporated by reference herein and made a part of this specification.

### BACKGROUND

1. Technical Field

The invention relates to a touch apparatus and control method thereof. Particularly, the invention relates to an optical touch apparatus and a touch method thereof.

2. Related Art

In an optical touch panel, light sources and light sensors are generally disposed at an edge of a screen. And a touch position can be calculated by using a triangulation location method according to analysis of sensing results of the light sensors and distances between the light sources. Although the aforementioned optical touch panel may reach a certain degree of touch accuracy in most cases, in case of a multi-touch operation, a problem that a touch point cannot be accurately determined still exists.

Patents related to the optical touch panel are U.S. Patent Publication No. 20110261016, U.S. Patent Publication No. 20100201637 and U.S. Patent Publication No. 20120205166.

### SUMMARY

The invention is directed to an optical touch apparatus and a touch method thereof, by which one or more ghost points generated during a multi-touch operation are eliminated to achieve better accuracy of the touch positions.

Additional aspects and advantages of the invention will be set forth in the description of the techniques disclosed in the invention.

To achieve one of or all aforementioned and other advantages, an embodiment of the invention provides an optical touch apparatus, which is applied to a touch surface. The optical touch apparatus includes a first scanning light source, a second scanning light source, a plurality of first light sensing units and a control unit. The first scanning light source emits a first scanning beam, and the second scanning light source emits a second scanning beam. The second scanning beam emitted from the second scanning light source and the first scanning beam emitted from the first scanning light source scan the touch surface in alternation. The first light sensing units, the first scanning light source and the second scanning light source are disposed at a first side of the touch surface. The first light sensing units are located between the first scanning light source and the second scanning light source for sensing a first scattered light generated by an input tool when the first scanning beam and the second scanning beam scan the input tool. The first light sensing units respectively correspond to a plurality of first sensing regions of the touch surface. The control unit is electrically connected to the first light sensing units, and determines the first sensing region where the input tool is located according to an intensity of the first scattered light sensed by the first light sensing units.

In an embodiment of the invention, each of the first light sensing units includes a plurality of light sensing diodes arranged at the first side of the touch surface in parallel.

In an embodiment of the invention, each of the light sensing diodes has a corresponding oblique angle according to a distance between a center point of the first scanning light source and the second scanning light source and the corresponding light sensing diode.

In an embodiment of the invention, the optical touch apparatus further includes a third scanning light source, a fourth scanning light source and a plurality of second light sensing units. The third scanning light source emits a third scanning beam. The fourth scanning light source emits a fourth scanning beam. The fourth scanning beam emitted from the fourth scanning light source, the first scanning beam emitted from the first scanning light source, the second scanning beam emitted from the second scanning light source and the third scanning beam emitted from the third scanning light source scan the touch surface in alternation. The second light sensing units are electrically connected to the control unit. The second light sensing units, the third scanning light source and the fourth scanning light source are disposed at a second side of the touch surface. The second light sensing units are located between the third scanning light source and the fourth scanning light source. The second light sensing units are used for sensing a second scattered light generated by the input tool when the third scanning beam and the fourth scanning beam scan the input tool, where the second light sensing units respectively correspond to a plurality of second sensing regions. The control unit determines the second sensing region where the input tool is located according to an intensity of the second scattered light sensed by the second light sensing units.

In an embodiment of the invention, each of the second light sensing units includes a plurality of light sensing diodes arranged at the second side of the touch surface in parallel.

In an embodiment of the invention, each of the light sensing diodes has a corresponding oblique angle according to a distance between a center point of the third scanning light source and the fourth scanning light source and the corresponding light sensing diode.

In an embodiment of the invention, the optical touch apparatus further includes a plurality of light blocking elements, and each of the light blocking elements is disposed at a side of the corresponding light sensing diode.

In an embodiment of the invention, the second side is opposite to the first side.

In an embodiment of the invention, the control unit determines the first sensing region where the input tool is located by ignoring sensing results obtained by the second light sensing units when the first scanning beam or the second scanning beam scans the touch surface, and the control unit determines the second sensing region where the input tool is located by ignoring sensing results obtained by the first light sensing units when the third scanning beam or the fourth scanning beam scan the touch surface.

The invention provides a touch method of an optical touch apparatus, wherein the optical touch apparatus is applied to a touch surface. The optical touch apparatus includes a first scanning light source, a second scanning light source, and a plurality of first light sensing units. The first light sensing units, the first scanning light source and the second scanning light source are disposed at a first side of the touch surface, and the first light sensing units are located between the first scanning light source and the second scanning light source, and the first light sensing units respectively correspond to a plurality of first sensing regions of the touch surface. The touch method of the optical touch apparatus includes following steps. The first scanning light source is used to emit a first scanning beam, and the second scanning light source is used to emit a second scanning beam. The first light sensing units are used to sense a first scattered light generated by an input tool when the first scanning beam and the second scanning beam scan the input tool, where the second scanning light source and the first scanning light source scan the touch surface in alternation. The first sensing region where the input tool is located is determined according to an intensity of the first scattered light sensed by the first light sensing units.

In an embodiment of the invention, the optical touch apparatus further includes a third scanning light source, a fourth scanning light source and a plurality of second light sensing units. The second light sensing units, the third scanning light source and the fourth scanning light source are disposed at a second side of the touch surface, and the second light sensing units are located between the third scanning light source and the fourth scanning light source. The second light sensing units respectively correspond to a plurality of second sensing regions. The touch method further includes following steps. The third scanning light source is used to emit a third scanning beam, and the fourth scanning light source is used to emit a fourth scanning beam, wherein the first scanning beam emitted from the first scanning light source, the second scanning beam emitted from the second scanning light source, the third scanning beam emitted from the third scanning light source and the fourth scanning beam emitted from the fourth scanning light source scan the touch surface in alternation, and the second light sensing units are used to sense a second scattered light generated by the input tool when the third scanning beam and the fourth scanning beam scan the input tool.

In an embodiment of the invention, the touch method further includes determining the second sensing region where the input tool is located according to an intensity of the second scattered light sensed by the second light sensing units.

In an embodiment of the invention, the touch method further includes determining the first sensing region where the input tool is located by ignoring a sensing result obtained by the second light sensing units when the first scanning beam and the second scanning beam scan the touch surface, and determining the second sensing region where the input tool is located by ignoring a sensing result obtained by the first light sensing units when the third scanning beam and the fourth scanning beam scan the touch surface.

According to the above descriptions, by configuring a plurality of the first light sensing units between the first scanning light source and the second scanning light source, an actual touch position of the input tool is determined according to the intensity of the first scattered light sensed by the first light sensing units. In this way, besides that the ghost point generated during the multi-touch operation is eliminated, the first sensing region where the input tool is located is also accurately determined from a plurality of first sensing regions of the touch surface.

In order to make the aforementioned and other features and advantages of the invention comprehensible, several exemplary embodiments accompanied with figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an optical touch apparatus according to an embodiment of the invention.

FIG. 2A and FIG. 2B are schematic diagrams of two types of the light sensing units according to an embodiment of the invention.

FIG. 3 is a schematic diagram of an optical touch apparatus according to another embodiment of the invention.

FIG. 4 is a schematic diagram of the optical touch apparatus according to another embodiment of the invention.

FIG. 5 is a flowchart illustrating a touch method for an optical touch apparatus according to an embodiment of the invention.

FIG. 6 is a flowchart illustrating a touch method for an optical touch apparatus according to another embodiment of the invention.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The present invention will now be described more fully with reference to the accompanying drawings, in which exemplary embodiments of the invention are shown. The terms used herein such as “above”, “below”, “front”, “back”, “left” and “right” are for the purpose of describing directions in the figures only and are not intended to be limiting of the invention.

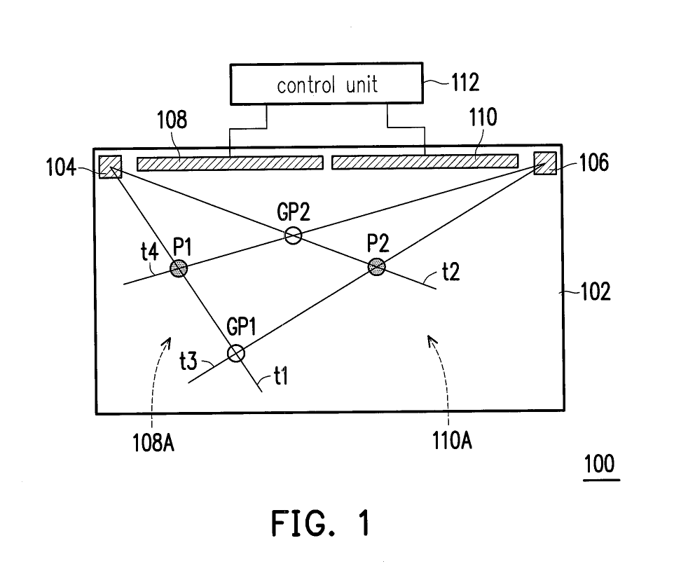

FIG. 1 is a schematic diagram of an optical touch apparatus according to an embodiment of the invention. Referring to FIG. 1, the optical touch apparatus 100 applied to a touch surface 102 includes a first scanning light source 104, a second scanning light source 106, two light sensing units 108,110 and a control unit 112, where the control unit 112 is electrically connected to the light sensing unit 108 and the light sensing unit 110. In the embodiment, the touch surface 102 can be a whiteboard, a projection screen, a desktop or a wall, etc., and a shape of the touch surface 102 is not limited to be a rectangle as that shown in FIG. 1, which can also be other geometric figures, for example, a circle or an arc, which can be varied along a design requirement.

According to the above descriptions, the first scanning light source 104, the second scanning light source 106, and the light sensing units 108, 110 are disposed at one side of the touch surface 102, as that shown in FIG. 1, the first scanning light source 104, the second scanning light source 106, and the light sensing units 108, 110 are disposed at an upper side of the touch surface 102. It should be noticed that the first scanning light source 104, the second scanning light source 106, and the light sensing units 108, 110 are not limited to be disposed at the upper side of the touch surface 102, and in other embodiments, the aforementioned components can also be disposed at other sides (a lower side, a left side or a right side) of the touch surface 102. Moreover, the light sensing units 108, 110 are disposed between the first scanning light source 104 and the second scanning light source 106. And the light sensing unit 108 is located between the first scanning light source 104 and the light sensing unit 110.

In the embodiment, the first scanning light source 104 and the second scanning light source 106 can respectively emit a first scanning beam and a second scanning beam according to a time sequence, and the first scanning beam emitted from the first scanning light source 104 and the second scanning beam emitted from the second scanning light source 106 scan a touch region on the touch surface 102 in alternation. As that shown in FIG. 1, the first scanning light source 104 and the second scanning light source 106 are disposed at different corners of the touch surface 102, and respectively change angles of the emitted first scanning beam and the emitted second scanning beam, so as to scan across the touch region on the touch surface 102. The first scanning beam emitted from the first scanning light source 104 is redirected from 0 to 90 degrees so as to scan the entire touch region on the touch surface 102. Similarly, the second scanning beam emitted from the second scanning light source may also scan the entire touch region on the touch surface 102 through a same manner.

The light sensing unit 108 and the light sensing unit 110 may perform light sensing during a scanning period of the first scanning light source 104 and the second scanning light source 106, and the control unit 112 may analyze signals received by the light sensing unit 108 and the light sensing unit 110 when an input tool performs a touch operation according to a triangulation location method, so as to obtain a touch position of the input tool, wherein the input tool is a finger, a stylus or other object capable of reflecting the scanning beam to perform the touch operation. However, as that shown in FIG. 1, besides the actual touch positions of the input tool are determined to be touch points P1 and P2, it is also required to determine ghost points GP1 and GP2. In the embodiment, sensing results of the light sensing units 108, 110 are compared to assist determination of the touch position of the input tool, so as to eliminate the ghost points GP1 and GP2 (which is described later).

According to the above descriptions, the light sensing unit 108 and the light sensing unit 110 may sense a scattered light generated from the input tool when the first scanning beam and the second scanning beam irradiate the input tool. The light sensing unit 108 and the light sensing unit 110 respectively have a corresponding sensing region. In detail, a sensing region 108A correspondingly sensed by the light sensing unit 108 is a left region of the touch surface 102, and a sensing region 110A correspondingly sensed by the light sensing unit 110 is a right region of the touch surface 102. In this way, the control unit 112 can determine the sensing region where the actual touch position of the input tool is located according to the scattered light intensity respectively sensed by the light sensing unit 108 and the light sensing unit 110. For example, the control unit 112 can calculate each position of the touch points P1 and P2 and the ghost points GP1 and GP2 according to the sensing results of the light sensing unit 108 and the light sensing unit 110. Further, by comparing the sensing results of the light sensing unit 108 and the light sensing unit 110, it can be determined that the points P1 and P2 are actual touch points, and the points GP1 and GP2 are ghost points. In detail, after the first scanning beam sequentially scans the points P1 and P2, and the second scanning beam sequentially scans the points P2 and P1, since the first scanning beam and the second scanning beam are intersected at the points GP1 and GP2 during scanning, the intensities of the light scattered from the two points GP1 and GP2 sensed by the light sensing unit 108 are all relatively stronger, and the intensities of the light at the two intersected points GP1 and GP2 sensed by the light sensing unit 110 are all relatively weaker. Namely, the two points GP1 and GP2 calculated by the control unit 112 according to the sensing results of the light sensing unit 108 and the light sensing unit 110 are all located at the left region. By comparing the sensing results of the light sensing unit 108 and the light sensing unit 110, it is known that such sensing results are unreasonable, so that it is determined that the points GP1 and GP2 are all ghost points. On the other hand, determination details of the touch points P1 and P2 may refer to descriptions of a following table one.

TABLE 1

| | Light intensity | Light intensity | Position of |
|---|---|---|---|
| Time | sensed by the light | sensed by the light | corresponding |
| point | sensing unit 108 | sensing unit 110 | touch point |
| t1 | Strong | Weak | Left region |
| t2 | Weak | Strong | Right region |
| t3 | Weak | Strong | Right region |
| t4 | Strong | Weak | Left region |

The table 1 lists sensing results of the scattered light intensities sequentially sensed by the light sensing unit 108 and the light sensing unit 110 at time points t1, t2, t2, t3 and t4, where the scattered light intensities sensed at the time points t1 and t2 are caused by the first scanning beam, and the scattered light sensed at the time points t3 and t4 are caused by the second scanning beam. When the light intensities sensed by the light sensing unit 108 is relatively strong, it represents that the touch position of the input tool is located at the left sensing region 108A on the touch surface 102. Comparatively, when the light intensities sensed by the light sensing unit 110 is relatively strong, it represents that the touch position of the input tool is located at the right sensing region 110A on the touch surface 102. Referring to the table 1, it is known that the actual touch positions of the input tool obtained according to the sensing results of the light sensing unit 108 and the light sensing unit 110 are respectively located at the left region and the right region. The control unit 112 calculates that the positions of the points GP1 and GP2 are all located at the left region (which is not described in the table 1) according to the sensing results of the light sensing unit 108 and the light sensing unit 110, so that the compared sensing results of the light sensing unit 108 and the light sensing unit 110 are not matched. Therefore, it is learned that the points GP1 and GP2 are ghost points which are required to be eliminated, and then the actual touch points P1 and P2 are determined.

Moreover, since the control unit 112 can accurately eliminate the ghost points, in some implementations, the touch surface 102 can be divided into two independent touch regions according to user's setting, i.e. a left touch region and a right touch region. In this way, two users can simultaneously perform touch operations by using the touch surface 102, so as to enhance the application of the touch surface 102. Moreover, when the user originally operated on the left touch region cross-touches the right touch region (or when the user originally operated on the right touch region cross-touches the left touch region), the control unit 112 interprets the touch operation as invalid, so as to avoid occurrence of false operations.

Further, the light sensing units 108, 110 may respectively include a plurality of light sensing diodes arranged at the side of the touch surface 102 in parallel. For example, in the embodiment of FIG. 1, the light sensing diodes can be disposed on the upper side of the touch surface 102 in parallel. It should be noticed that in order to improve accuracy that the control unit 112 determines the sensing region where the input tool is located according to the sensing results of the light sensing unit 108 and the light sensing unit 110. In some implementations, light blocking elements can be used to shield the light that probably causes a false determination, or a configuration direction of the light sensing diodes can be adjusted.

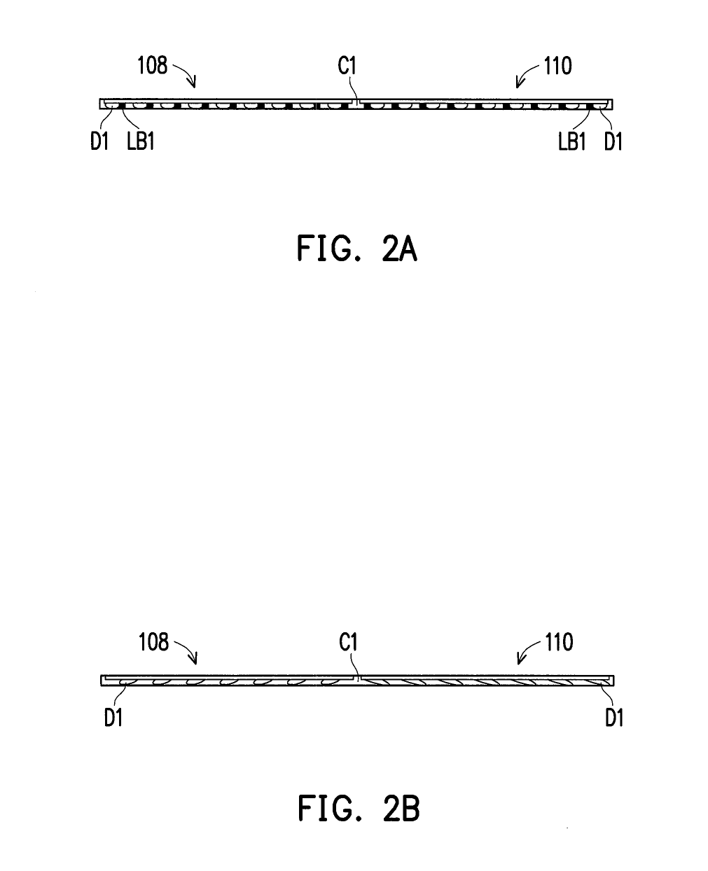

For example, FIG. 2A and FIG. 2B are schematic diagrams of two types of the light sensing units according to an embodiment of the invention. In FIG. 2A, the light sensing unit 108 and the light sensing unit 110 respectively include a plurality of light sensing diodes D1 and a plurality of light blocking elements LB1, wherein each of the light blocking elements LB1 is disposed between the corresponding light sensing diode D1 and a center point C1 between the first scanning lights source and the second scanning light source (which are not illustrated in FIG. 2A). In this way, a chance that the light sensing unit 108 receives the scattered light from the right sensing region 110A (shown in FIG. 1) of the touch surface 102 is decreased or avoided, and a chance that the light sensing unit 110 receives the scattered light from the left sensing region 108A (shown in FIG. 1) of the touch surface 102 is decreased or avoided, such that the control unit 112 can accurately determine the actual touch position.

On the other hand, in FIG. 2B, the light sensing unit 108 and the light sensing unit 110 respectively include a plurality of the light sensing diodes D1, wherein each of the light sensing diodes D1 is obliquely configured away from the center point C1 between the first scanning light source and the second scanning light source (which are not illustrated in FIG. 2), and in this way, the chance that the light sensing unit 108 receives the scattered light from the right sensing region 110A (shown in FIG. 1) of the touch surface 102 is decreased or avoided, and a chance that the light sensing unit 110 receives the scattered light from the left sensing region 108A (shown in FIG. 1) of the touch surface 102 is decreased or avoided. It should be noticed that in FIG. 2B, oblique angle of each light sensing diode D1 in the light sensing unit 108 is the same, and oblique angle of each light sensing diode D1 in the light sensing unit 110 is also the same. In some implementations, the light sensing diodes D1 may have different oblique angles along with different distances between the light sensing diodes D1 and the center point C1 between the first scanning light source and the second scanning light source. For example, the greater the distance between the corresponding light sensing diode D1 and the center point C1 between the first scanning light source and the second scanning light source is, the greater the oblique angle of the corresponding light sensing diode D1 deviates from the center point C1 between the first scanning light source and the second scanning light source, i.e. the oblique angle of the light sensing diode D1 away from the center point C1 between the first scanning light source and the second scanning light source is larger relative to the oblique angle of the light sensing diode D1 close to the center point C1 between the first scanning light source and the second scanning light source. In this way, the sensing sensitivity of the light sensing unit 108 and the light sensing unit 110 can be enhanced through the oblique angles of the light sensing diodes D1.

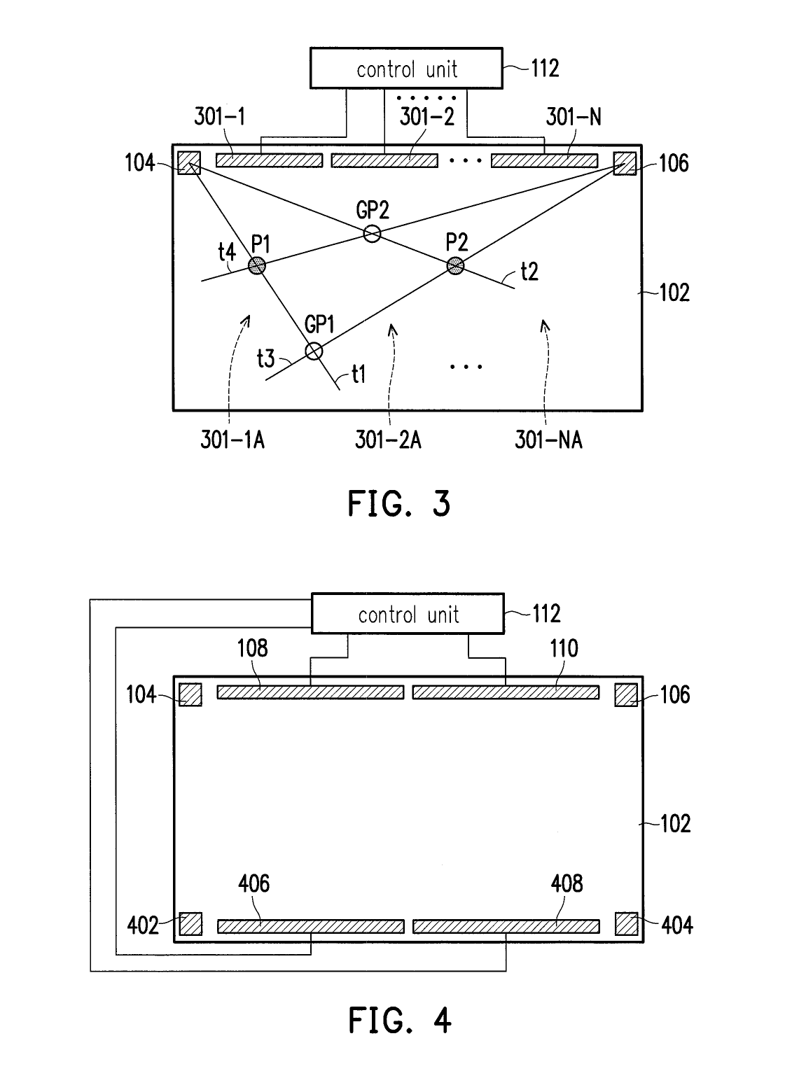

Moreover, although two light sensing units 108 and 110 are taken as an example for descriptions in the embodiment of FIG. 1, in a practical application, the number of the light sensing units can be increased to enhance the accuracy that the control unit 112 determines the actual touch position. FIG. 3 is a schematic diagram of an optical touch apparatus according to another embodiment of the invention. Referring to FIG. 3, a plurality of light sensing units 301-1˜301-N are configured between the first scanning light source 104 and the second scanning light source 106, where N is a positive integer. The more the number of the light sensing units is, the more accurate that the determination of the real touch position of the input tool is. Since the operation principle of the optical touch apparatus has been described in detail in the embodiment of FIG. 1-FIG. 2B, those skilled in the art can deduce the implementation of the present embodiment according to the content of the embodiment of FIG. 1-FIG. 2B, and details thereof are not repeated.

FIG. 4 is a schematic diagram of the optical touch apparatus according to another embodiment of the invention. Referring to FIG. 4, a difference between the optical touch apparatus in the embodiment of FIG. 4 and the optical touch apparatus in the embodiment of FIG. 1 is that the optical touch apparatus in the embodiment of FIG. 4 further includes a third scanning light source 402, a fourth scanning light source 404, and two light sensing units 406, 408. The third scanning light source 402, the fourth scanning light source 404, the light sensing unit 406 and the light sensing unit 408 are disposed at the lower side of the touch surface 102, i.e. disposed at a side opposite to the side where the first scanning light source 104, the second scanning light source 106, the light sensing unit 108 and the light sensing unit 110 are located.

As that described above, the light sensing unit 406 and the light sensing unit 408 are sequentially disposed between the third scanning light source 402 and the fourth scanning light source 404, and the light sensing unit 406 is located between the third scanning light source 402 and the light sensing unit 408. The control unit 112 is electrically connected to the light sensing unit 108, the light sensing unit 110, the light sensing unit 406 and the light sensing unit 408. Similarly, the third scanning light source 402 and the fourth scanning light source 404 can respectively emit the third scanning beam and the fourth scanning beam, and the first scanning light source 104, the beams emitted from the second scanning light source 106, the third scanning light source 402 and the fourth scanning light source 404 scan the touch region of the touch surface 102 in alternation. Moreover, the light sensing units 108, 110, 406 and 408 can respectively sense the light scattered from the input tool when the first scanning beam, the second scanning beam, the third scanning beam and the fourth scanning beam scan the input tool, and the light sensing unit 108, the light sensing unit 110, the light sensing unit 406 and the light sensing unit 408 respectively have the corresponding sensing region on the touch surface 102, where the sensing regions corresponding to the light sensing units 108, 110, 406 and 408 are, for example, respectively an upper left region, an upper right region, a lower left region and a lower right region of the touch surface 102, though the invention is not limited thereto. Implantations of the light sensing unit 406 and the light sensing unit 408 may refer to the embodiments of FIG. 2A and FIG. 2B, and details thereof are not repeated.

Similar to the embodiment of FIG. 1, the control unit 112 of FIG. 4 can also determine the sensing region where the real touch position of the input tool is located according to an intensity of the scattered light caused by the input tool and sensed by the light sensing unit 406 and the light sensing unit 408, where the determination method thereof can be similar to the determination method of the embodiment of FIG. 1, and details thereof are not repeated, and there can be more touch sensing regions.

However, in the embodiment of FIG. 4, regarding the sensing result obtained by the light sensing unit 406 and/or 408 when the first scanning beam and/or the second scanning beam scan the touch surface 102, the control unit 112 can be set not to take the sensing result as a determination condition for determining the sensing region where the real touch position of the input tool is located. Similarly, regarding the sensing result obtained by the light sensing unit 104 and/or 106 when the third scanning beam and/or the fourth scanning beam scan the touch surface 102, the control unit 112 can be set not to take the sensing result as a determination condition for determining the sensing region where the real touch position of the input tool is located. In this way, in the embodiment, the control unit 112 does not use the sensing result obtained by the light sensing unit when the scanning beam emitted from the scanning light source on the other side scans the touch surface 102 for determining the actual touch position, so as to avoid a situation that the control unit 112 misjudges the touch position of the input tool according to a false sensing result.

Moreover, the number of the light sensing units between the first scanning light source 104 and the second scanning light source 106 and the number of the light sensing units between the third scanning light source 402 and the fourth scanning light source 404 are not limited by the invention. In some implementations, the number of the light sensing units between the first scanning light source 104 and the second scanning light source 106 and/or the number of the light sensing units between the third scanning light source 402 and the fourth scanning light source 404 can be more than three. When greater the number of the light sensing unit is, the more sensing regions the touch surface 102 may have.

In other embodiments, the optical touch apparatuses according to the above embodiments can be tiled and merged (not shown) to increase a touch operation area of the sensing region.

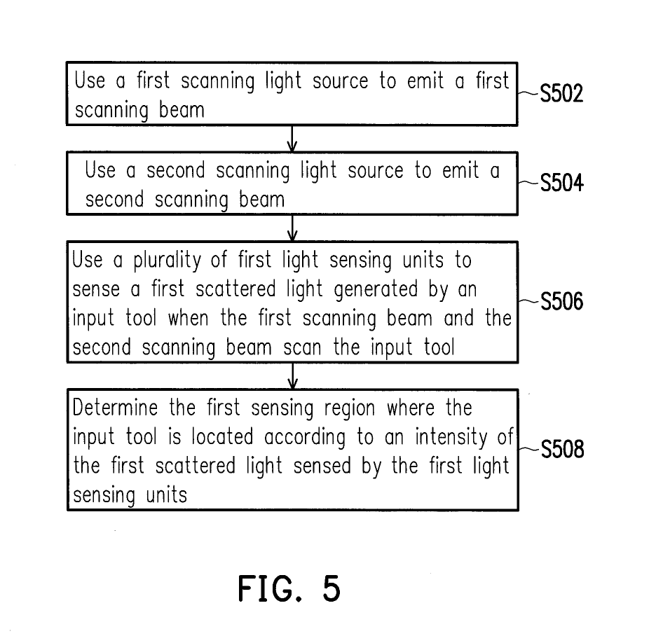

FIG. 5 is a flowchart illustrating a touch method for an optical touch apparatus according to an embodiment of the invention. Referring to FIG. 5, the touch method of the optical touch apparatus includes following steps. First, the first scanning light source is used to emit a first scanning beam (step S502), wherein the first light sensing units, the first scanning light source and the second scanning light source are disposed at a first side of the touch surface, and the first light sensing units are located between the first scanning light source and the second scanning light source, and the first light sensing units respectively correspond to a plurality of first sensing regions. Then, the second scanning light source is used to emit a second scanning beam (step S504), wherein the second scanning beam emitted from the second scanning light source and the first scanning beam emitted from the first scanning light source scan the touch surface in alternation. Thereafter, a plurality of the first light sensing units are used to sense a first scattered light generated by the input tool when the first scanning beam and the second scanning beam scan the input tool (step S506). Then, the first sensing region where the input tool is located is determined according to an intensity of the first scattered light sensed by the first light sensing units (step S508).

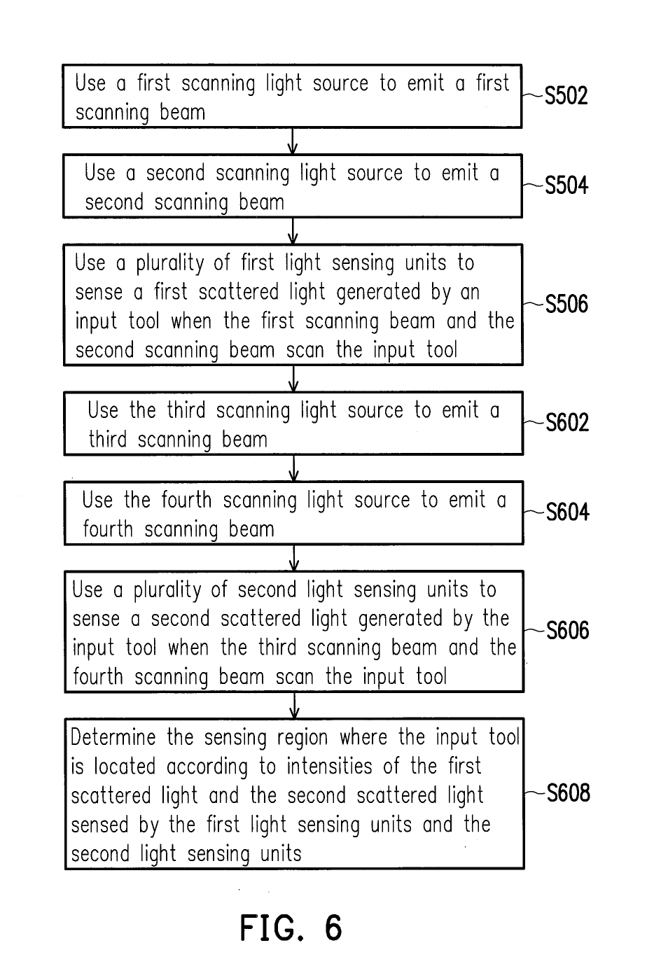

FIG. 6 is a flowchart illustrating a touch method for an optical touch apparatus according to another embodiment of the invention. A difference between the embodiment of FIG. 6 and the embodiment of FIG. 5 is that the optical touch apparatus of the embodiment of FIG. 6 further includes a third scanning light source, a fourth scanning light source, and a plurality of second light sensing units, wherein the second light sensing units, the third scanning light source and the fourth scanning light source are disposed at the second side of the touch surface. Moreover, the second light sensing units are located between the third scanning light source and the fourth scanning light source, and the second light sensing units respectively correspond to a plurality of second sensing regions of the touch surface.

According to the above descriptions, the touch method of the optical touch apparatus further includes following steps. The third scanning light source is used to emit a third scanning beam (step S602), the fourth scanning light source is used to emit a fourth scanning beam (step S604), a plurality of the second light sensing units are used to sense a second scattered light generated by the input tool when the third scanning beam and the fourth scanning beam scan the input tool (step S606). Then, a sensing region where the input tool is located is determined according to intensities of the first scattered light and the second scattered light sensed by the first light sensing units and the second light sensing units (step S608). The embodiments of FIG. 5-FIG. 6 can be deduced with reference of the operation principle of the optical touch apparatus, and details thereof are not repeated.

In summary, the actual touch position of the input tool is determined according to the configuration of a plurality of light sensing units between the first scanning light source and the second scanning light source and the intensity of the scattered light sensed by the light sensing units. Besides that the ghost points generated during the multi-touch operation are eliminated, the sensing region where the input tool is located is also accurately determined from a plurality of sensing regions on the touch surface. In some implementations, the third scanning light source, the fourth scanning light source and the light sensing units can be further disposed at a side opposite to the side where the first scanning light source, the second scanning light source and the light sensing units are located, so as to further increase the number of the sensing regions of the optical touch apparatus. Moreover, the aforementioned light sensing units can be implemented by light sensing diodes, and the accuracy for determining the actual touch position of the input tool can be further enhanced by disposing the light blocking elements adjacent to the light sensing diodes or adjusting the configuration direction of the light sensing diodes.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching and are not used to limit the invention. The terms “first”, “second”, etc. mentioned in the specification and the claims are merely used to name the elements and should not be regarded as limiting the upper or lower bound of the number of the components/apparatuses.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical touch apparatus, applied to a touch surface, and the optical touch apparatus comprising:
a first scanning light source, emitting a first scanning beam;
a second scanning light source, emitting a second scanning beam, wherein the second scanning beam emitted from the second scanning light source and the first scanning beam emitted from the first scanning light source scan the touch surface in alternation;
a plurality of first light sensing units, disposed at a first side of the touch surface together with the first scanning light source and the second scanning light source, and the first light sensing units being located between the first scanning light source and the second scanning light source for sensing a first scattered light generated by an input tool when the first scanning beam and the second scanning beam scan the input tool, wherein the first light sensing units respectively correspond to a plurality of first sensing regions of the touch surface; and
a control unit, electrically connected to the first light sensing units, and determining the first sensing region where the input tool is located according to an intensity of the first scattered light sensed by the first light sensing units.

2. The optical touch apparatus as claimed in claim 1, wherein each of the first light sensing units comprises:
a plurality of light sensing diodes, arranged at the first side of the touch surface in parallel.

3. The optical touch apparatus as claimed in claim 2, wherein each of the light sensing diodes has a corresponding oblique angle according to a distance between a center point of the first scanning light source and the second scanning light source and the corresponding light sensing diode.

4. The optical touch apparatus as claimed in claim 2, further comprising:
a plurality of light blocking elements, wherein each of the light blocking elements is disposed at a side of the corresponding light sensing diode.

5. The optical touch apparatus as claimed in claim 1, further comprising:
a third scanning light source, emitting a third scanning beam;
a fourth scanning light source, emitting a fourth scanning beam, wherein the fourth scanning beam emitted from the fourth scanning light source, the first scanning beam emitted from the first scanning light source, the second scanning beam emitted from the second scanning light source and the third scanning beam emitted from the third scanning light source scan the touch surface in alternation; and
a plurality of second light sensing units, electrically connected to the control unit, disposed at a second side of the touch surface together with the third scanning light source and the fourth scanning light source, and the second light sensing units being located between the third scanning light source and the fourth scanning light source for sensing a second scattered light generated by the input tool when the third scanning beam and the fourth scanning beam scan the input tool, wherein the second light sensing units respectively correspond to a plurality of second sensing regions, and the control unit determines the second sensing region where the input tool is located according to an intensity of the second scattered light sensed by the second light sensing units.

6. The optical touch apparatus as claimed in claim 5, wherein each of the second light sensing units comprises:
a plurality of light sensing diodes, arranged at the second side of the touch surface in parallel.

7. The optical touch apparatus as claimed in claim 6, wherein each of the light sensing diodes has a corresponding oblique angle according to a distance between a center point of the third scanning light source and the fourth scanning light source and the corresponding light sensing diode.

8. The optical touch apparatus as claimed in claim 6, further comprising:
a plurality of light blocking elements, wherein each of the light blocking elements is disposed at a side of the corresponding light sensing diode.

9. The optical touch apparatus as claimed in claim 5, wherein the second side is opposite to the first side.

10. The optical touch apparatus as claimed in claim 5, wherein the control unit determines the first sensing region where the input tool is located by ignoring sensing results obtained by the second light sensing units when the first scanning beam or the second scanning beam scans the touch surface, and the control unit determines the second sensing region where the input tool is located by ignoring sensing results obtained by the first light sensing units when the third scanning beam or the fourth scanning beam scan the touch surface.

11. A touch method of an optical touch apparatus, wherein the optical touch apparatus is applied to a touch surface, the touch method comprising:
using a first scanning light source to emit a first scanning beam;
using a second scanning light source to emit a second scanning beam, wherein the second scanning beam emitted from the second scanning light source and the first scanning beam emitted from the first scanning light source scan the touch surface in alternation;
using a plurality of first light sensing units to sense a first scattered light generated by an input tool when the first scanning beam and the second scanning beam scan the input tool, wherein the first light sensing units respectively correspond to a plurality of first sensing regions of the touch surface, wherein the first light sensing units, the first scanning light source and the second scanning light source are disposed at a first side of the touch surface, and the first light sensing units are located between the first scanning light source and the second scanning light source; and
determining the first sensing region where the input tool is located according to an intensity of the first scattered light sensed by the first light sensing units.

12. The touch method of the optical touch apparatus as claimed in claim 11, further comprising:
using the third scanning light source to emit a third scanning beam; and
using the fourth scanning light source to emit a fourth scanning beam, wherein the first scanning beam emitted from the first scanning light source, the second scanning beam emitted from the second scanning light source, the third scanning beam emitted from the third scanning light source and the fourth scanning beam emitted from the fourth scanning light source scan the touch surface in alternation; and
using the second light sensing units to sense a second scattered light generated by the input tool when the third scanning beam and the fourth scanning beam scan the input tool, wherein the second light sensing units respectively correspond to a plurality of second sensing regions of the touch surface, and the second light sensing units, the third scanning light source and the fourth scanning light source are disposed at a second side of the touch surface, and the second light sensing units are located between the third scanning light source and the fourth scanning light source.

13. The touch method of the optical touch apparatus as claimed in claim 12, further comprising:
determining the second sensing region where the input tool is located according to an intensity of the second scattered light sensed by the second light sensing units.

14. The touch method of the optical touch apparatus as claimed in claim 13, further comprising:
determining the first sensing region where the input tool is located by ignoring sensing results obtained by the second light sensing units when the first scanning beam and the second scanning beam scan the touch surface; and
determining the second sensing region where the input tool is located by ignoring sensing results obtained by the first light sensing units when the third scanning beam and the fourth scanning beam scan the touch surface.
